(19) United States
(12) Patent Application Publication
(10) Pub. No.: US 2015/0261812 A1
(43) Pub. Date: Sep. 17, 2015

(54) Method to form social groups in various contexts to enable ease of information sharing and communication

(71) Applicant: Siva Prakasa Reddy Pappula, Fremont, CA (US)

(72) Inventor: Siva Prakasa Reddy Pappula, Fremont, CA (US)

(21) Appl. No.: 14/214,941

(22) Filed: Mar. 15, 2014

(51) Int. Cl. G06F 17/30; H04L 29/08; H04L 12/18

(52) U.S. Cl. CPC G06F 17/30386; H04L 12/1813; H04L 67/30

(57) ABSTRACT

A method to establish a social group in real time is provided. The method comprises collection of a user's interest information through a software application provided on the user's computing device. The method further matches the user's interest query with interest information of other users kept in the main system server. The system server then identifies various users having common interest information as that of the user and creates a social group of such users.

### CROSS-REFERENCE(S) TO RELATED APPLICATIONS

This application takes priority from U.S. provisional application No. 61/802,106 filed on 15 Mar. 2013

### TECHNICAL FIELD

This disclosure generally relates to social networking, and more particularly to formation of a social group based on real time interest of a user.

### BACKGROUND

The popularity and growth of social network sites and services has increased dramatically over the last few years. Existing social network sites include Facebook, Google+, Twitter, MySpace, YouTube, LinkedIn, Flicker, Jaiku, MYUBO, Bebo and the like. Such social networking sites are typically organized around user profiles and/or collections of content accessible by members of the network. Membership in such social networks is comprised of individuals, or groupings of individuals, who are generally represented by profile pages and permitted to interact as determined by the social networking service.

In many popular social networks, especially profile-focused social networks, activity centres on web pages or social spaces that enable members to communicate and share activities, interests, opinions, status updates, audio/video content, etc. across networks of contacts. Social networking services might also allow members to track certain activities of other members of the social network, collaborate, locate and connect with former acquaintances and colleagues, establish new connections with other members and share various kinds of information among its members.

While social networks are usually comprised of individuals, members might also include companies, restaurants, political parties and event profiles that are represented in a like manner to human members (e.g., profile pages accessible by members of a social network). Individual members typically connect to social networking services through existing web-based platforms via a computing device and/or mobile smartphone. Smartphone and games-based mobile social networking services are other rapidly developing areas.

Whereas, the social networks have made it easy to share information among its users, however, constantly there is a need of presenting the ever increasing information in a better way.

### SUMMARY

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

According to an embodiment of the invention a method to form a social group based on a real time interest query raised by a user is provided. The method further identifies other users having related information to the interest query raised by the user and forms a group real time so as to facilitate exchange of various information.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

Reference will be made in detail to embodiments of the disclosure, non-limiting examples of which may be illustrated in the accompanying drawing figures (FIGs). The figures may be in the form of diagrams. Some elements in the figures may be exaggerated or drawn not-to-scale; others may be omitted, for illustrative clarity. Any text (legends, notes, reference numerals and the like) appearing on the drawings are incorporated by reference herein. When terms such as “left” and “right”, “top” and “bottom”, “upper” and “lower”, “inner” and “outer”, or similar terms are used in the description, they may be used to guide the reader to orientations of elements in the figures, but should be understood not to limit the apparatus being described to any particular configuration or orientation, unless otherwise specified or evident from context. Different “versions” of elements may be referenced by reference numerals having the same numbers (###) followed by a different letter suffix (such as “A”, “B”, “C”, or the like), in which case the similar elements may be inclusively referred to by the numeric portion (###) only of the reference numeral

FIG. 1 illustrates the block diagram for implementation of a social group.

FIG. 2 illustrates exemplary specific entities that can be formed using the invention.

FIG. 3a illustrates the connection permissions within a social group as according to an embodiment of the invention.

FIG. 3b illustrates various derived privileges between various interconnected social groups in accordance to an embodiment of the invention

FIG. 4 depicts the various access based roles and privileges available to various categories of users.

FIG. 5 illustrates a specific example of sharing messages across interconnected social groups.

FIG. 6 depicts member to member communication within the social group for a specific entity.

FIG. 7 illustrates an individual user as a specific entity.

FIG. 7a illustrates a group which is geographically organized

FIG. 7b illustrates a point of sale system which links up a product to a user social group

FIG. 8 illustrates the formation of sub entities within a social group.

FIG. 9 depicts a table to illustrate exemplary services offered by the social group system.

FIG. 9a illustrates a recommendation scheme implementation

FIG. 10 illustrates an example operating environment in which the invention may function.

FIG. 11 is a schematic block diagram of a sample-computing environment

FIG. 12a depict a table to illustrate initial set of search results.

FIG. 12b depict a table to illustrate a final set of optimized search results.

### DETAILED DESCRIPTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

The embodiments and aspects thereof may be described and illustrated in conjunction with systems, devices and methods which are meant to be exemplary and illustrative, not limiting in scope. Specific configurations and details may be set forth in order to provide an understanding of the invention(s).

However, it should be apparent to one skilled in the art that the invention(s) may be practiced without some of the specific details being presented herein. Furthermore, some well-known steps or components may be described only generally, or even omitted, for the sake of illustrative clarity.

Reference herein to “one embodiment”, “an embodiment”, or similar formulations, may mean that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

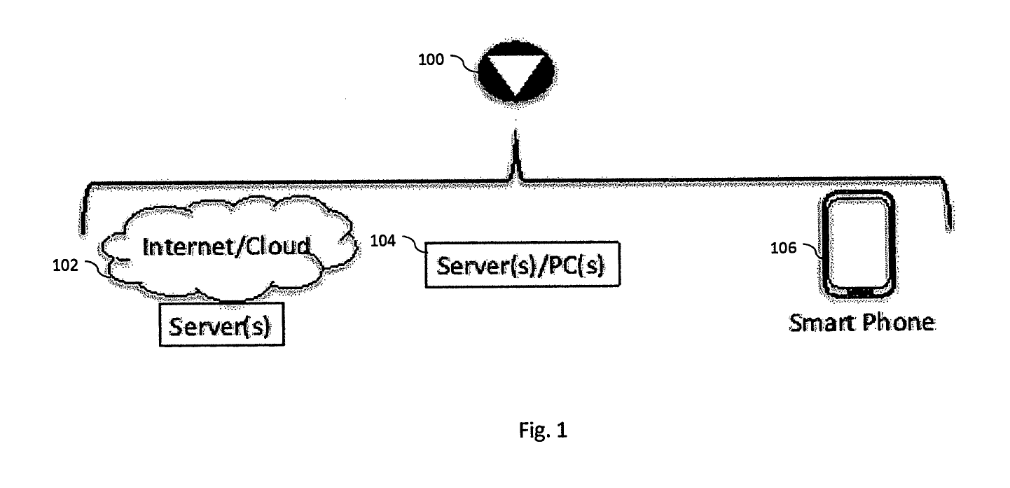

Referring to FIG. 1, which depicts the formation of a social group 100 in various ways. In one embodiment of the invention the social group 100 is implemented through a mobile device 106. This can be achieved through a mobile application on the mobile application. In furtherance to this the implementation to this embodiment can also be achieved by storing some of the content on cloud 102. The information of the social group 100 can be propagated using REST framework or JSON or XML coding.

The logic for creation of the social group 100 can also be stored in various plugins or extensions into any existing mobile applications. The implementation ca also be achieved through web based applications. For this to achieve the process is hosted on a remote server which can be accessed via various protocols such as HTTP/HTTP(s). The logic for creation of the social group 100 can also be written within the applications made for various social media platforms.

In another embodiment of the invention, the social group 100 can also be implemented through a personal computer 104.

The social group 100 however not limiting to the scope of the invention, an application software system. As described above the social group 100 can be implemented as an application running on a mobile device 106 or a personal computer 104 running as an application running on various mobile platforms such as iPhone, Android, Microsoft tablet and other types of computer systems which have given memory and ability to interact with users. The application software system residing on a main server (not shown in the figure) maintains certain information about the social group 100 which may be, however not limiting to the scope of the invention, type of the social group 100, name, certain identifiers, description, keywords, databases, files and objects, users privileges and roles, message filter rules, settings, current location of a user, location history of the user, and other information. The mobile devices 106 or the personal computer 104 can contact the main server to locate other relevant virtual specific entities and gather information about the social group 100. In some embodiments the mobile device 106 may cache various information related to the social group 100 to improve performance and responsiveness to users. Social group systems servers can be implemented as single or groups of servers with facility to back the information, distribute the load and provide high resilience against various failures. In some embodiments, the social group 100 can be created manually, by user specifying the entity details. In other embodiments, the social group 100 may be created automatically by system. For example, automatically creating a social group for all restaurants in a given area. In yet another embodiment of the invention various other social groups can be connected to the social group 100. Also, in some embodiments the social group 100 can be connected to email, web and other interfaces as well.

In one embodiment MiniWorld records are help on remote server. For each Social group the server keeps track of Name, Identifier, Keywords, Location, Category and other information. This serves as facility to easily locate a given Social group

### Explanation for Connection Formation of Social Groups:

### Static Connection Formation:

A user may request to identify a set of relevant social groups based on certain key terms or keywords or any other information or any combination thereof. The request of the user is taken by the software application and forwarded to the main server. The main server returns to the user, results related to the query input from him. A set of social groups presented to the user after which if the user may wish he may select either one of the social groups or multiple social groups as per his interest to join. Therefore, the user may also join multiple social groups at a time.

### Dynamic Connection Formation:

As mentioned above in the description connecting to the social group 100, enables users to gather relevant information and discussion. Therefore, dynamic connection formation is provided in order to provide the user facility to find relevant information when he is on the move. This may be based on context, such as events, activities or other interests of the user. The information of the virtualized social entity system is updated so as to indicate the dynamic connections at any point of time as per the user's movement. In one embodiment of the invention the social group 100 can automatically connect to a nearby other virtualized social entities. Connection can be based on user's interest/history or through user's explicit search request. Also, optionally the connection may be automatically terminated when the user is physically away or is not active, from the virtualized social entity to which he was connected dynamically.

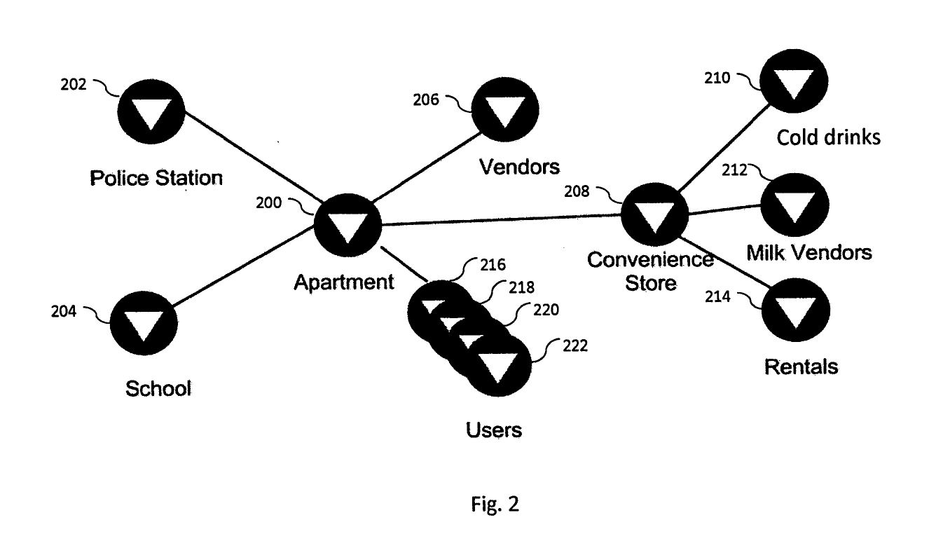

FIG. 2, illustrates a social group 200 connected to another social group 208 and the various services available to the users 216, 218, 220 and 222 within these connected groups. In an exemplary embodiment of the invention, however not limiting to the scope of the invention, a social group could be an apartment 200 which has further other various social groups like police station group 202, school group 204, vendors group 206 like plumber, electrician etc., convenience store group 208 which is further connected to cold drinks services group 210, milk vendors group 212, and rentals group 214 which could be video renting etc. The various users 216, 218, 220 and 222 who are connected to the apartment group 200 can access services in the groups which are connected to the apartment group 200. Hence, a facility is provided to join large number of social groups at once. In the way of example, search for social group can be done using distance as a measure i.e. list all the specific groups which are within 50 miles radius. Once the list of specific groups is returned, user can decide to join all the social groups which are retuned by the query. Social groups can be identified through various factors such as topic of interest, physical distance and other means. Once the social group is detected a request to join the social group is made. In some embodiments, this is accomplished by clicking “Join” button on the screen of a computing device or through a gesture on a touch screen device.

In another embodiment of the invention, connecting to social group helps in gathering relevant information and discussion. To support scenarios where the user is on move and wants to find relevant information based on nearby specific entities or based on context, such as events, activity or other interests, dynamic connections of specific entities is allowed. In one embodiment a given virtual specific entity automatically connects to a nearby specific entities. Optionally, when user is physically away from a dynamically connected social group without any activity then user's connection to a given social group is removed. The users connected with the social group are able to share messages which can be anyone of conversations, chats, news, information, reviews, recommendations, and, questions amongst themselves. The messages shared can be categorized as anyone, but not limiting to the scope of the invention as a global message, a shared message, or a private message.

In yet another embodiment of the invention, in cases where a forum that results into a social group does not have a true physical association i.e. there may be users from various locations of the world who want to participate in a group etc. This forum may be represented as a social group. Users associated with this social group may also be optionally organized into further sub groups with basic attributes for e.g. physical location of users, interests of users etc. Such a sub grouping enables creation of a local sub group so as to enable interaction between local users as well.

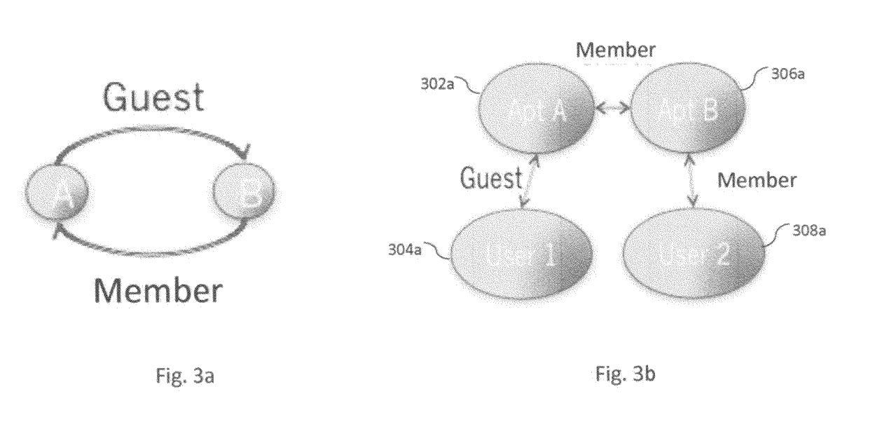

FIG. 3a illustrates the connection permissions within a social group connected to a social group. In an embodiment of the invention a social group can be formed automatically by a system or manually by a user. When a new social group is formed and is connected to another social group then, only public information is accessible by default. Through various authorization methods, other privilege levels such as a member or an owner can be obtained. In one embodiment, this is implemented by user sending an access level request to existing owners. Owner on viewing the request decides the right privilege level for the user.

In another embodiment of the invention different level of access is provided as well Specific Example: as shown in the FIG. 3a user A might have guest level permission on B, but B might have member level access to user A.

FIG. 3b illustrates various derived privileges between various interconnected social groups in accordance to an embodiment of the invention. In an embodiment of the invention Apartment A 302a (depicted as Apt A) is a social group which is connected to Apartment B (depicted as Apt B) 306a. User1 304a belongs to a social group for Apt A 302a. User2 belongs to a social group for Apt B 306a. User1 304a has guest access to Apt A 302a. User2 has member level access to Apt B. Even though Apt A and Apt B have member privilege, User1 will only get guest level access to Apt B.

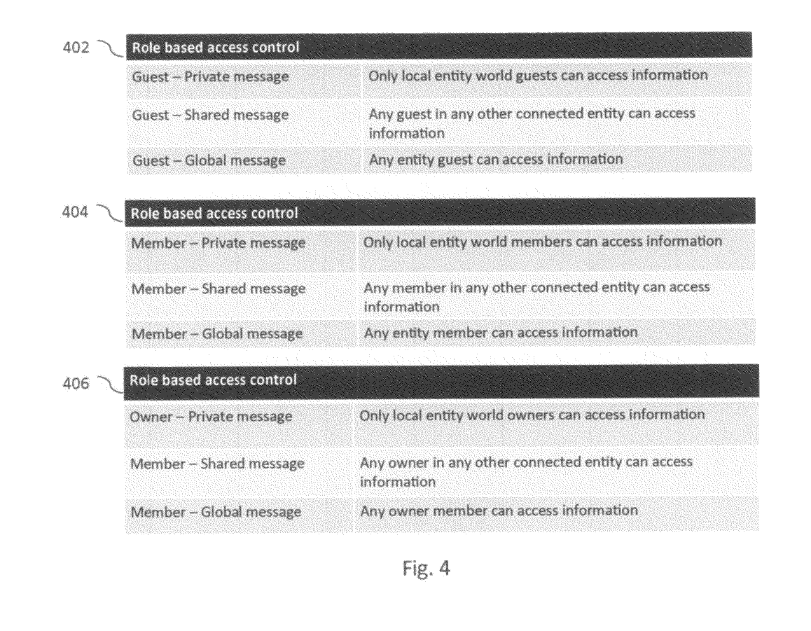

Referring to FIG. 4, it depicts tables to illustrate various types of access that can be provided to users with various types of roles. References will be made to FIG. 2 to explain the context of the invention. As shown in table 402, the role based access control for a user assigned with a guest role within the social group connected to the social group 100. As mentioned above in the description, the information posted by the user can also be further classified into various categories. As table 402 depicts when a guest user posts a private message to the social group 100, this message can be accesses by only those guest users which are connected to the social group 100. However, if the guest user posts a message classified as a shared message to the social group 100, then this message can be accessed by any guest user in any social group connected to the social group 100. Furthermore, if the guest user posts a message classified as a global message, then any guest in any social group can whether connected to the social group 100 or not, can access the message. This is because one user may be connected to multiple specific entities which might or might not be connected to each other.

Further as depicted in table 404 when a member user posts a private message to the social group 100, this message can be accesses by only those member users which are connected to the local social group 100. However, if the member user posts a message classified as a shared message to the social group 100, then this message can be accessed by any member user in any social group connected to the social group 100. Furthermore, if the member user posts a message classified as a global message, then any member in any social group can whether connected to the social group 100 or not, can access the message. This is because one user may be connected to multiple specific entities which might or might not be connected to each other.

Further as depicted in table 406 when an owner user posts a private message to the social group 100, this message can be accesses by only those owner users which are connected to the local social group 100. However, if the owner user posts a message classified as a shared message to the social group 100, then this message can be accessed by any owner user in any social group connected to the social group 100. Furthermore, if the owner user posts a message classified as a global message, then any owner in any social group can whether connected to social group 100 or not, can access the message. This is because one user may be connected to multiple social groups which might or might not be connected to each other.

In another embodiment of the invention, various roles can also be assigned to various connected social groups. For e.g. as depicted in FIG. 2 the Apartment social group 200 which is connected to Police station social group 202 can have anyone of an owner role, a guest role, or a member role.

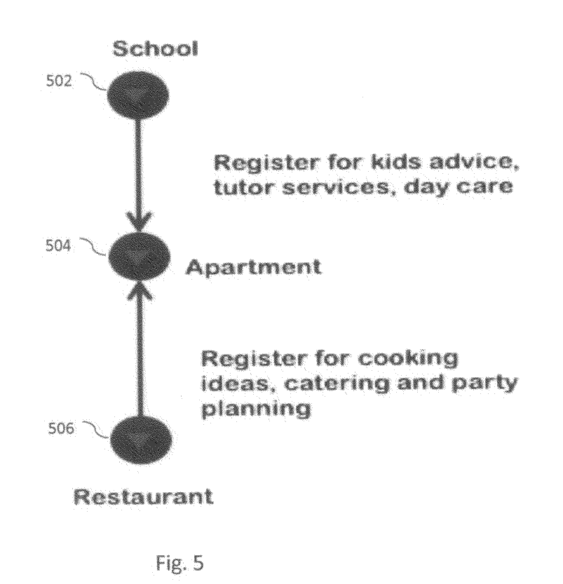

Moving further to FIG. 5, which illustrates message filtering within interconnected social groups. In an embodiment of the invention, a social group can specify set of services and interest a given social group is interested in participating. Based on this information, services and messages to connected mini-worlds are limited.

For example, as shown in the FIG. 5, a school social group 502 is connected to an apartment social group 504. The apartment social group 504 is also connected to a restaurant social group 506. According to the invention, the school specific can specify that it is interested in kids and education topics. This limits the school social group to these topics and filter any posts from coming to the school social group from the apartment social group. When a service request is made by a social group, a cyclic connect graph is constructed, using well known computer science algorithms like dijkstra's however, not limiting to the scope of the invention. In this graph message is sent only on links which have proper permission, as described by role based access control. In some embodiments facility is provided for message propagation speeds. For e.g. traverse up to 5 connected worlds per day or post it to communities within 50 miles.

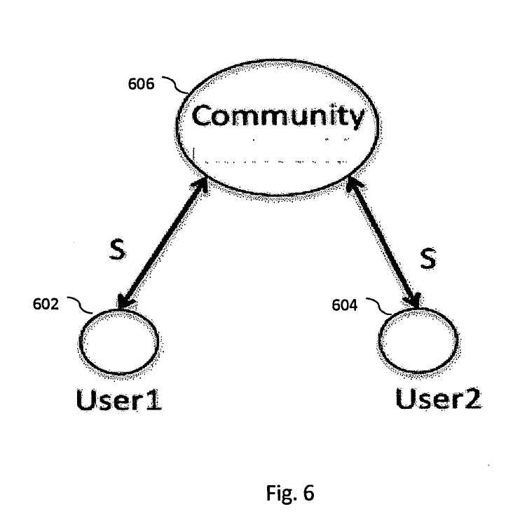

FIG. 6 illustrates a specific member to member communication as per one embodiment of the invention. As shown in the FIG. 6 two member User1 602 and User2 604 are connected to a community social group 606. If the users 602 and 604 are not directly connected to each other, then each user can only see public information of other user. Only after connecting with that user, information with shared or owner level privilege might be accessible. Two users who are not connected via any graph will not be able to reach directly. However, paid service, or by requesting permission from connecting set of social group in a graph is allowed. For e.g. If User1 602 who is not directly connected to User2 604 can request to view User1's 602 information by paying certain amount to community social group 606 to which both User1 602 and User2 604 are connected. To request for User1's 602 details the User2 604 might be required to register himself. This can be done by filing up of an electronic form by the User2 604, to register himself to the social group 606.

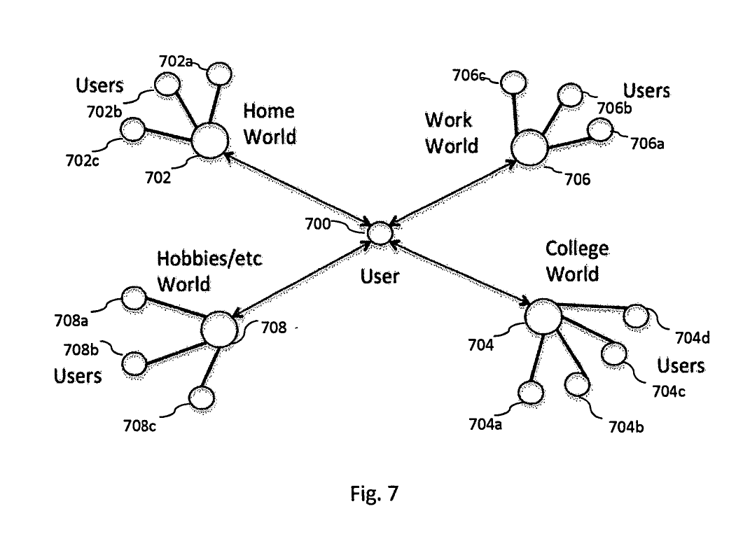

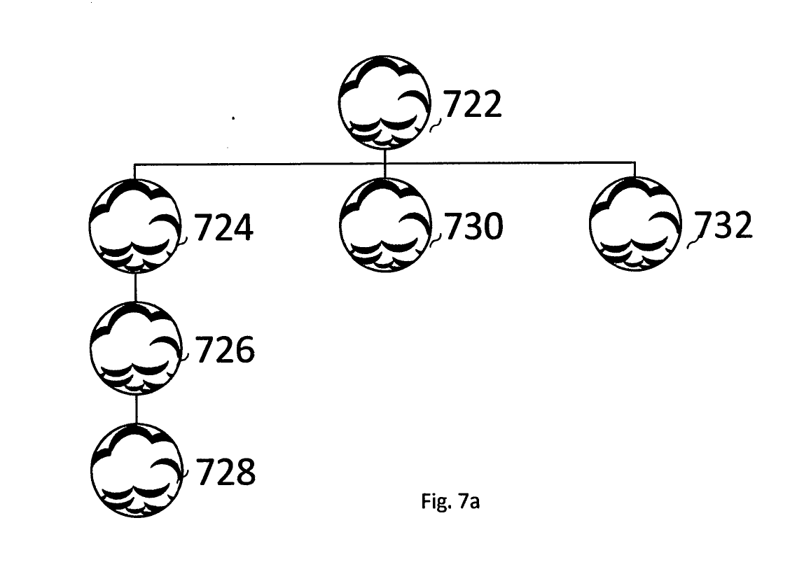

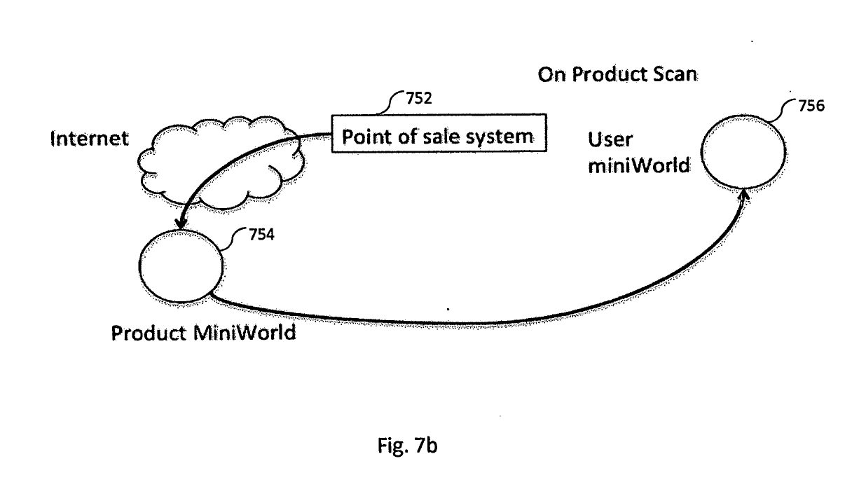

Referring to FIG. 7, as per another embodiment of the invention an individual 700 can also be a social group. In a real group user might end up with set of groups. For example, home 702, work 706, college 704, Hobbies/play 708 etc. A User will have friends, family and acquaintances at each group. In an embodiment of the invention the user 700 can post a specific message to his work group 706 which will be only accessible to users 706a. 706b, and 706c connected to the user 700 through his work group 706. Similarly the user can post a specific message to his Hobbies group 708 which will only be accessible to users 708a, 708b, and 708c connected to the user 700 through his Hobbies group 708. Further, the users 704a, 704b, 704c, and 704d can also see those posts which the user 700 posts to his college group 704. Also, the users 702a, 702b, and 702c can also see those posts which the user 700 posts to his Home group 702.

This setting allows the user 700 to post message to a selected communities to limit the scope of a given information. In addition, system automatically creates set of useful lists, such as all friends, family, friends at home, friends at work, professional network and the like. This enables the user 700 to be selective and share information with these communities. User 700 can use traditional methods such as email to post information to these communities as well.

However, in another embodiment of the invention the user 700 can also decide to share some information between more than one connected groups. For e.g. he may share come information with both the home group 702 and the college group 704 simultaneously.

### Geo Social Group:

In some embodiments, where forum or group or any other need, that results in entity which doesn't have a true physical association i.e. there are users from many different parts of the world that participate in a group, forum or other entities. FIG. 7a shows the example where a logical group 722 is automatically split by physical region basis. For e.g. the logical group 722 is a soccer social group. It can be further split into country wise soccer groups like USA soccer social group 724, Brazil soccer group 730, and Japanese soccer social group 732. Further, the USA soccer social group 724 can be further split into State soccer social group 726 which could further have social groups of individual soccer social groups of states like California soccer social group 728 and etc.

This entity is represented as social group. Users associated with this social group are optionally organized into groups based attributes such as physical location, interests etc. Such grouping enables creating a local community in which users can also interact physically.

### Entity Social Group:

Various physical entities such as Mall, Office, Car, Cruise ship, Train, Ship, Plane, Airport, Airport gate, Restaurant can have mini world. This enables communication with different entities at these places.

For example Car social group enables facility for other to communicate with owner of the car. For example, if owner forgot to turn off the light, then person who noticed that can send message to owner using messaging facility.

People traveling by train or plane and waiting at terminal can communicate with each other, vendors, and transportation authorities. For example this facility enables users to keep up to date on the departure even if the user is away to get food etc., In addition this setting will also be helpful to place automated orders to nearby restaurants and business.

In some cases it might be desired to restrict the access of the Mini World only when the participants are physically in a close proximity to the location of a given MiniWorld. Examples are Arena, where a specific event is occurring, Air port terminals and like. In some embodiments acceptance to a Mini World occurs only after the location information has been validated to meet such needs.

In some cases when some event occurs, user might be looking for specific information. For example, on entering a class room student may want to access course material for that hour and day. In order to facilitate such use cases, in some embodiments facility is provided where various actions can be assigned on various events. For example, on entering a given MiniWorld push some information to the clients.

Mobile devices and other systems might have different tarrifs during different times of days. And also different tarrifs based on the mode of access. For example, access of internet might be free through WiFi, but user gets charged when using 3G or 4G connection. To optimize events based download in such situations, system actively maintains likelyhood of user attending a given MiniWorld and an request to access a given material on a given day. This could be implemented using standard statistical methods. Once there is high certainty that user might needs specific material ahead of the occurrence of the event and user has free internet connection, then the content is pre-downloaded. For devices which are powered through battery as battery life is important, highest preference is given to message download when system has active power connection and also has free internet access. Following this preference is given to download when user has free internet connection.

### Product Mini World

Each product can also have a social group of its own. This enables businesses to contact the users of product easily when need arises. In addition users of product can act as source of reference to the business entity. For user of product it becomes easy to locate help by easily locating the business support personal who are also connected to the product social group

In addition facilities are provided which automates enrolment of user to a given product social group 752. In one embodiment, shown in FIG. 7b, point of sale system 754 during the transaction on getting the user details from the user's social group 756 and is able to automatically enroll the user. In other embodiments once the business gets sale transaction and associated user information, can automatically add user to the product social group 754, assuming that proper consent is obtained from user.

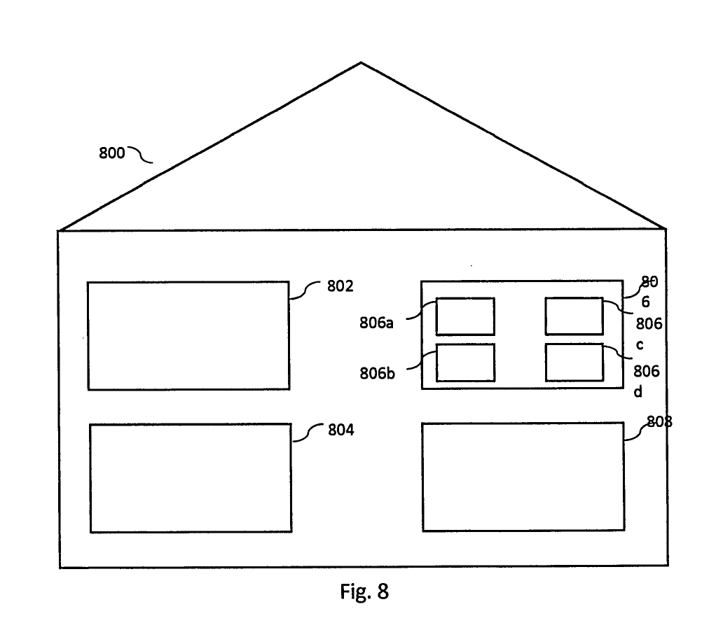

FIG. 8 illustrates formation of various sub groups 802, 804, 806, and 808 within a social group 800. In an embodiment of the invention however, not limiting to the scope of the invention, a social group 800 can be a shopping mall. Since a shopping mall may comprise of many shops hence the mall entity 800 spanning entire mall may not meet the needs of visiting users. Hence, various smaller virtualized sub entities are created for individual stores, brands, etc. within the virtualized mall group 800. In an embodiment, the virtualized mall entity 800 can be further divided into a pharmacy sub group 802, a Daily needs sub group 804, an office supplies group 808, and an electronics sub group 806. In an another embodiment of the invention the electronics sub group can also be further divided into various sub groups like laptops sub group 806a, a washing machine sub group 806b, a television sub group 806c, and a mobile phone sub group 806d.

Ability is provided to group multiple groups into higher level domains: Example: School friends, which includes College, High school miniWorlds. Ability is provided to post information to logical groups is provided. Also, capabilities are provided to control how the information propagation from logical group to individual groups. I.e. user can specify different filter mechanism in logical group formation which is applied before information is propagated.

### Set of Services Offered

Services and information provided by services is optionally influenced by connected social groups (or previously visited social groups). I.e. when user is connected to one or more-social groups, then services and services results are optionally adjusted based on the information from these social groups.

### Example 1

Say there is Top10 movie list a-Social group A. Also, Top10 movie list at-social group B. When user is connected to both the-social groups, a new Top10 list is created based on Top10 list from A and B. This process is done by merging the lists. If a given movie is listed in both sets, then it is given high priority. Also, other information such as number of reviews etc., are also taken into consideration.

### Example 2

Say user is trying to figure out which camera to buy (Say, Sony vs Canon). In recommendation/product search, recommendations of connected users in-social group is taken into consideration. In addition, if there is product review or product ownership of connected users, then this product is given higher importance.

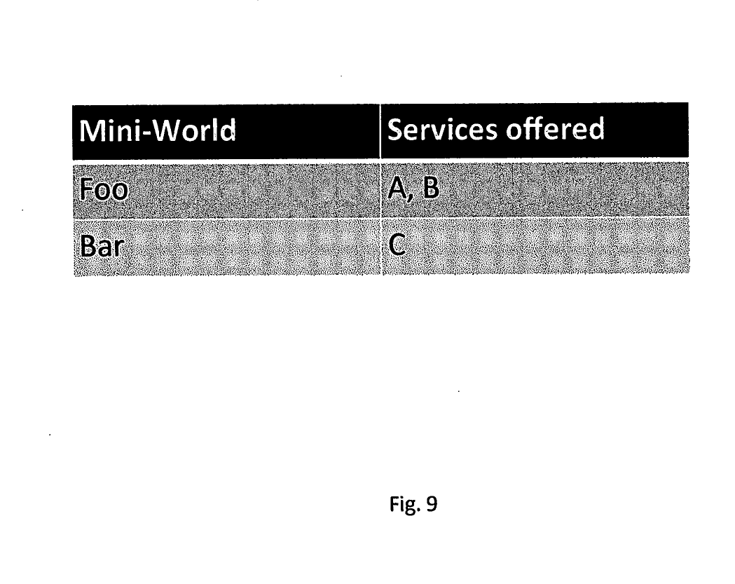

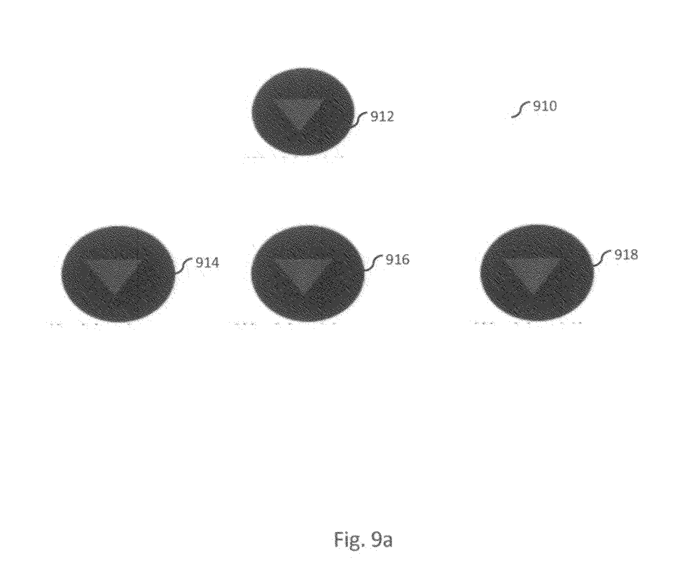

An exemplary embodiment of the services is depicted in FIG. 9. Services offered to user connected to both Foo and Bar are

A, B and C. In addition other services specific to user are also shown.

### Group Based Recommendation

Referring to FIG. 9a illustrated a recommendation scheme 910 according to an embodiment of the invention. When user belonging to a social group 912 searches for recommendation, information of the connected social groups i.e. 914 which is one connection away, 916 which is two connections away, and 918 which is three connections away are also taken into account to customize the search results. For e.g.: if the user belonging to social 912 is looking to get recommendation on movie to watch. To provide the results, in addition for system looking for aggregate movie rating (say country wide), suggestions from the user's connected social groups i.e. 914, 916, and 918 are also taken into account to refine the recommendations.

### Exemplary Calculation:

Let us say each of the social groups have following movies at the top movies

| Groups at one | Group At two | Group at three |
|---|---|---|
| Distance away | Connections away | connections away |
| Theta | Alpha | A |
| Omega | C | B |
| D | B | C |
| A | PI | D |

These can be merged into one list by following logic:

| | | | | Group at | |
|---|---|---|---|---|---|
| | | Group at two | | three | |
| Group at one | | connection | | connections | |
| distance away | Weight | away | Weight | away | Weight |
| Theta | 4 × 8 | Alpha | 4 × 4 | A | 4 × 2 |
| Omega | 3 × 8 | C | 3 × 4 | B | 3 × 2 |
| D | 2 × 8 | B | 2 × 4 | C | 2 × 2 |
| A | 1 × 8 | PI | 1 × 4 | D | 1 × 2 |

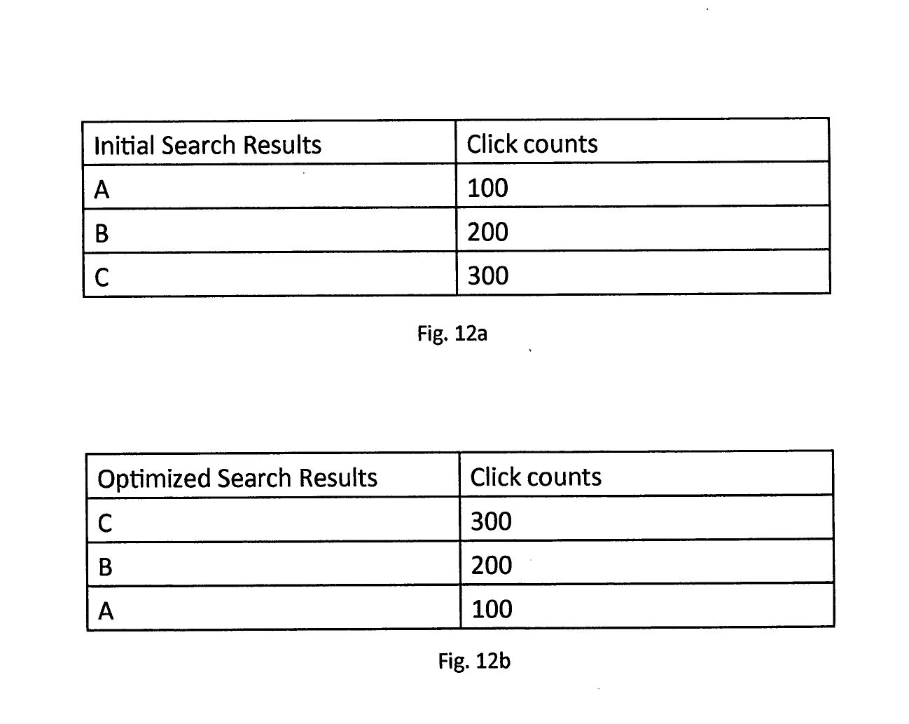

Once this is done all the users weight is added up into single list, sorted by weight. Resulting list is presented to user. Note: if more than one items with equal weight are seen then item are ordered in random from these sets. In addition list is optimized based on user clicks, which is illustrated in FIGS. 12a and 12b. In addition, user preferences also influence the results.)

| | |
|---|---|
| Theta | 4 × 8 = 32 |
| Omega | 3 × 8 = 24 |
| D | 2 × 8 + 1 × 2 = 18 |
| Alpha | 4 × 4 = 16 |
| A | 1 × 8 + 4 × 2 = 16 |
| C | 3 × 4 + 2 × 2 = 16 |
| B | 2 × 4 + 3 × 2 = 14 |
| PI | 1 × 4 = 4 |

In addition search can be narrowed to set of connected mini group using various factors such as but not limited to, physical distance, distance in terms of connected groups. Eg. Search within three connected group distance.

In some instances based on the user behaviour and other information, system performs following operations which are commonly performed. This information is cached. For example: Restaurant to go to, Places to visit, Product reviews

### Search Caching and Optimization:

As community has typically similar type of general search requests, top searches are cached by system, so that they can be augmented. In addition search resulted are presented along with specific ads and other information to help monetize the service.

### Exemplary Search Optimization:

FIG. 12a illustrates a table wherein the search results depict an initial set of search results. As per the interaction between various users and the search results as depicted in the table of FIG. 12a gets optimized to the order as depicted in table of FIG. 12b. To optimize search results user feedback with search results is used. For example, various users clicks on specific results are tracked. These interactions are tracked to optimize the search results ordering as shown in FIG. 12b.

### Referral

One of the benefits of the social network such as social group is it makes it very easy to find the information such as referrals, recommendations. For example, Nanny serving a person in a community can connect to that person. Through the functionality specified in FIG. 5, Nanny can register for “Nanny” service. A user in community who is looking for Nanny can search the social group and locate the Nanny.

Through this facility user will be able to communicate with Nanny, read the ratings, schedule appointment to meet etc., In cases where multiple ratings exists for a given entity exist then weighted average method is used to provide a final rating. In this scheme higher weight is given to reviews from users who are socially close to the user.

Social group system support referral fee payout. In order to support this, system keeps track of contact made by a person looking for a reference or recommendation with the provider of service. Once the entity in future establishes connection with the user, at that time fee is charged. Person looking for reference is also reminded periodically about the reference fees. In some embodiments the provider of service may also get charged on communication made with person looking for that service.

### Rewards Payout

In some embodiments referral fees got is split between different entities. If only one person made the referral i.e. had review for the provider of service or able to provide the information directly (say via phone call), then referral fee is split between referring, referred and the social group system.

If multiple people are involved in recommending a person distance, number of visits, additional clarification provided i.e. via phone, email, IM etc., are taken into account. For example, say two users provide rating, then closet user is given higher share. For example, say two users provide rating, then frequently visited user is given higher share. For example, say two users provide rating, then user who takes call from referred to provide additional clarification is given higher share.

To promote business a provider of service can connect with various physical worlds to offer advice, get noticed and also to show up in search results. In one embodiment business entities get charged by number of connections made.

### Business and Community Engagement Platform:

Mini World facility provides a new platform for the local business to engage with communities. For example, a local restaurant can register to a nearby community using the facility mentioned in FIG. 5. Restaurant can send promotions to the community. In addition to keep the engagement restaurant can even make video say which show how to make a specific verity of dish. In some embodiments provider of services might get charged for posting multi-media messages. In one embodiment videos of similar categories are combined to create a periodic video show.

### Business Aspects: Reward System and Revenue for Community

To encourage user activity various rewards are given. In one embodiment, annual subscription is charged to the user, with an offer of free service per year. Users are rewarded with points for various activates. Points are designed such that majority of the users through various activates accumulate enough points each year to pay for the annual subscription fees. In addition varying reward mechanism is charged for different types of social groups.

### Following is Sample Reward Schedule:

### Example

Rewards for message posts and replies. Rewards when user replies to advice (points from requester are assigned). Reward points can be used to pay the annual fees. Intention is service is free to the user who are actively contributing to the system. In addition, rewards are given in varying fashion to users and business.

| Description | Points |
|---|---|
| Create account | +1200 |
| Per month of account cost | −100 |
| Post a message | +10 |
| Reply to a message | +5 |
| Solicit advice | −10 |
| Answer advice | +10 by user, Custom charge by SMEs |
| Create event | +50 |
| Event participation | +10 |
| Get referral | −10 (for business) |
| Post video | −10 (for business) and +10 (for user) |
| Interactive quiz | +10 per user and −10 for business |
| Pay X$ | +Y points |

When user joins a miniWorlds ability is provided automatically provide certain information. Benefits: This helps with user registration, filling form and other such things. System shows the information requested. User can selectively allow certain parts of asked information

For soliciting advice facilities are provided for user to assign points or money for a given message to get faster response.

Search term entered is categorized into results which might benefit from social interaction and also local interaction. Eg. Best nearby restaurant, Best movie etc., Out of these frequently used search terms are maintained. Generic search results of any popular search engines used are cached. User click of search results are used to further boost the search terms as it will have better guess for results for given user at a given vicinity. Recommendations: Search, local: Search result caching and optimization

Ads pre-caching: Certain adds suitable in context which the user is most likely interested in are downloaded and saved. These advertisements are shown even when the network connectivity is not present. When network connectivity is not present, cached landing page information is also shown with sufficient details to complete the transaction to a level where reset of the transaction can be completed using phone, if not as soon the internet connection is available. Vendors can bit for different spots for ad

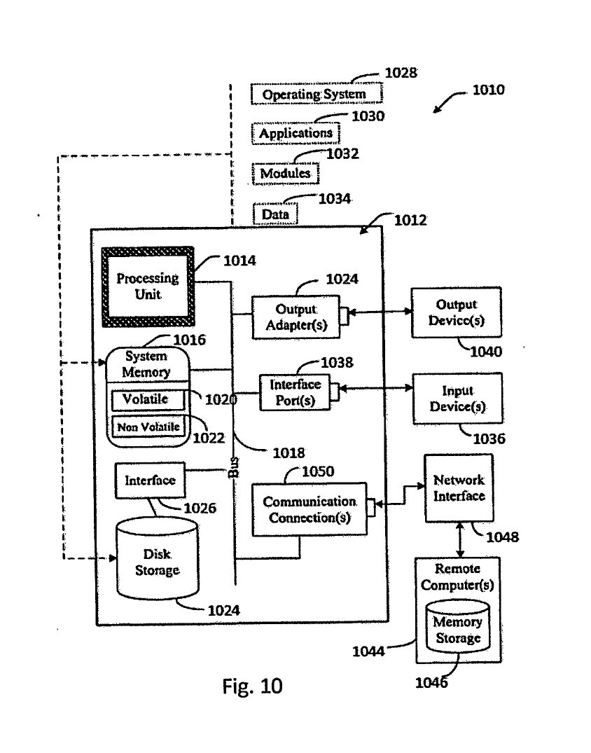

With reference to FIG. 10, an exemplary environment 1010 for implementing various aspects of the subject invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structures) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

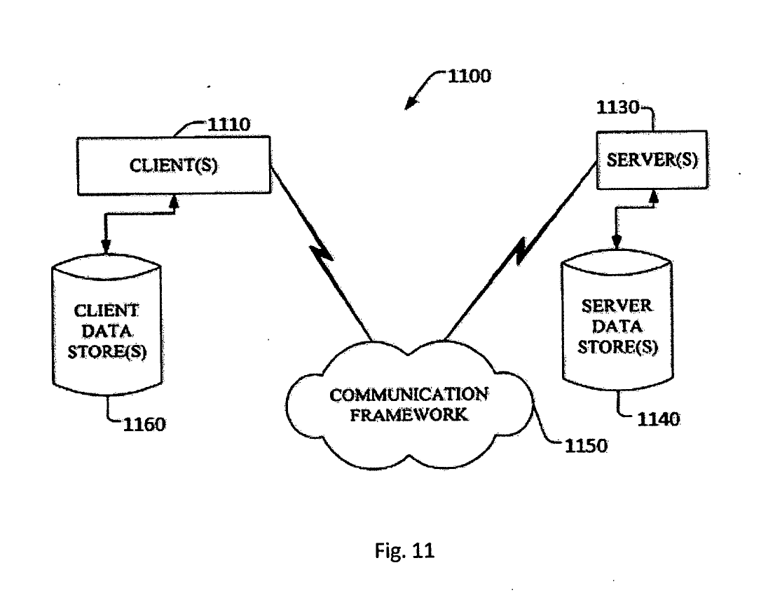

FIG. 11 is a schematic block diagram of a sample-computing environment 1100 with which the present invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the present invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for establishing a social group real time, the method comprising;
receiving an interest query from a user, wherein the user inputs his query into a computing device;
matching the query interest of the user with information of other users;
identifying other users based on some common interest acquired through matching; and
forming the social group, wherein the social group is formed based on the common interests of the identified users.

2. The method of claim 1, wherein the computing device is anyone of a mobile, a tablet computer, a laptop, a personal computer, car's system, or a personal digital assistant.

3. The method of claim 1, further comprising exchanging of various information by the users connected with on a set of interests.

4. The method of claim 1, wherein the social group is formed automatically.

5. The method of claim 1, wherein the social group is formed manually.

6. The method of claim 5, wherein the formation of the group of users is through a click of a button.

7. The method of claim 5, wherein the formation of the social group of users is through gesture on a touch screen.

8. The method of claim 1, further comprising assigning various roles to the users of the social group.

9. The method of claim 9, wherein the various roles are from anyone of an owner, a member, or a guest.

10. The method of claim 1, further comprising posting of messages by the users connected with the virtualized specific entity.

11. The method of claim 12, wherein the messages are any one of conversations, chats, news, information, reviews, recommendations, and, questions.

12. The method of claim 11, further comprising classifying the messages as anyone of a global message, a shared message, or a private message.

13. The method of claim 1, further comprising registering a new user to connect to the social group.

14. The method of claim 14, wherein the registration is by way of filling a form.

15. The method of claim 15, wherein the form is provided on anyone of a mobile, a tablet computer, a laptop, a personal computer, car's system, or a personal digital assistant.

16. The method of claim 1, wherein the virtualized specific entity is identified by a location, an event, a name description, an incident, an individual, or a scan able coded image.

17. The method of claim 1, wherein the virtualized specific entity is connected to another virtualized specific entity.

18. The method of claim 18, wherein various roles are assigned to connected specific entities from any one of an owner, a member, or a guest.
